(19) United States
(12) Patent Application Publication
(10) Pub. No.: US 2010/0225655 A1
(43) Pub. Date: Sep. 9, 2010

(54) Concurrent Encoding/Decoding of Tiled Data

(75) Inventors: Jackson Tung, Saratoga, CA (US); B. Anil Kumar, Saratoga, CA (US); Kai Chee Li, Fremont, CA (US); Thomas Young, Foster City, CA (US); Francis A. Palita, Goodyear, AZ (US); Viswa Krishnamurthi, Santa Clara, CA (US); Mark S. Zheng, San Jose, CA (US); Hao Guo, Cupertino, CA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/399,627

(22) Filed: Mar. 6, 2009

(51) Int. Cl. G06T 1/00; G06K 9/36

(52) U.S. Cl. 345/522; 382/233

(57) ABSTRACT

Example embodiments of the present disclosure provide techniques for dividing bitmaps into tiles and processing the tiles concurrently using multiple tile engines. Data compression algorithms may be adapted so that the algorithms can be concurrently processed by multiple data slice engines. The algorithms may be further adapted so that the concurrent outputs for each stage may be passed to the next processing stage without delays or dead cycles. The reduction or elimination of delays or dead cycles may result in a lower latency.

### CROSS-REFERENCE

This application is related by subject matter to the subject matter disclosed in the following commonly assigned applications, the entirety of which are hereby incorporated by reference herein: U.S. patent application Ser. No. ______ (Attorney Docket No. MVIR-537/326424.01) titled “Frame Buffer Management,” U.S. patent application Ser. No. ______ (Attorney Docket No. MVIR-0535/326267.01) titled “Frame Capture, Encoding, and Transmission Management,” and U.S. Pat. No. 7,460,725 entitled “System And Method For Effectively Encoding And Decoding Electronic Information.”

### BACKGROUND

Remote computing systems can enable users to access resources hosted by the remote computing systems. Servers on the remote computing systems can execute programs and transmit signals indicative of a user interface to clients that can connect by sending signals over a network conforming to a communication protocol such as the TCP/IP protocol. Each connecting client may be provided a session, i.e., an execution environment that includes a set of resources. Each client can transmit signals indicative of user input to the server and the server can apply the user input to the appropriate session. The clients may use protocols such as the Remote Desktop Protocol (RDP) to connect to a server resource.

In the remote desktop environment, data representing graphics to be transmitted to the client are typically compressed by the server, transmitted from the server to the client through a network, and decompressed by the client and displayed on the local user display. Various schemes may be used to minimize the size of the graphics data that needs to be transmitted. One such scheme may include dividing the graphics data into tiles and sending only the tiles that have changed since a previous transmission. However, the changed tiles still need to be encoded and transmitted, typically requiring significant network bandwidth and a significant number of processor computation cycles to compress and decompress the tiles. Such processing requirements may have a direct effect on the data transmission/decoding latency from the server to the client and negatively impact the remote user's experience. Thus, additional techniques are needed in the art to solve the above described problems.

### SUMMARY

In various embodiments, methods and systems are disclosed for dividing bitmaps into tiles and processing the tiles concurrently using multiple tile engines. Data compression algorithms may be adapted so that the algorithms can be concurrently processed by multiple data slice engines. The algorithms may be further adapted so that the concurrent outputs for each stage may be passed to the next processing stage without delays or processor idle cycles. The reduction or elimination of delays or idle cycles may allow for reduced latencies.

Various aspects are disclosed herein for a mechanism to allow concurrent processing of one or more portions of a data compression and decompression algorithm with multiple data slice engines. In some embodiments, the concurrent processing may be performed in custom hardware.

In addition to the foregoing, other aspects are described in the claims, drawings, and text forming a part of the present disclosure. It can be appreciated by one of skill in the art that one or more various aspects of the disclosure may include but are not limited to circuitry and/or programming for effecting the herein-referenced aspects of the present disclosure; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

FIG. 1 depicts an example computer system wherein aspects of the present disclosure can be implemented.

FIG. 1a illustrates an exemplary virtual machine environment.

FIGS. 2 thru 4 depict an operational environment for practicing aspects of the present disclosure.

FIG. 5 illustrates a block diagram depicting one embodiment of an encoding system.

FIG. 6 illustrates a block diagram depicting one embodiment of an decoding system.

FIG. 7 illustrates one embodiment of a frame differencing procedure.

FIG. 8 illustrates one embodiment of a frame reconstruction procedure.

FIG. 9 illustrates one embodiment of an entropy encoder.

FIG. 10 illustrates one embodiment of an entropy decoder.

FIG. 11 illustrates one embodiment of a multiple encoder-decoder architecture.

FIG. 12 illustrates one embodiment of a multiple image encoding/decoding procedure.

FIG. 13 illustrates one embodiment of tile data.

FIG. 14 illustrates a flowchart of operations for performing an encoding procedure.

FIG. 15 illustrates a flowchart of operations for performing a decoding procedure.

FIG. 16 illustrates flowchart of operations for performing an encoding procedure.

FIG. 17 illustrates one embodiment of data tile slice encoding procedure.

FIG. 18 illustrates one embodiment of data tile slice decoding procedure.

FIG. 19 illustrates a detailed embodiment of data tile slice encoding procedure.

FIG. 20 illustrates a detailed embodiment of data tile slice decoding procedure.

FIG. 21 illustrates an example of an operational procedure for compressing graphics data for transmission to a client computer.

FIG. 22 illustrates an example system for compressing data for transmission to a client computer.

FIG. 23 illustrates a computer readable medium bearing computer executable instructions discussed with respect to FIGS. 1-22.

### DETAILED DESCRIPTION

### Computing Environments In General Terms

Certain specific details are set forth in the following description and figures to provide a thorough understanding of various embodiments of the disclosure. Certain well-known details often associated with computing and software technology are not set forth in the following disclosure to avoid unnecessarily obscuring the various embodiments of the disclosure. Further, those of ordinary skill in the relevant art will understand that they can practice other embodiments of the disclosure without one or more of the details described below. Finally, while various methods are described with reference to steps and sequences in the following disclosure, the description as such is for providing a clear implementation of embodiments of the disclosure, and the steps and sequences of steps should not be taken as required to practice this disclosure.

It should be understood that the various techniques described herein may be implemented in connection with hardware or software or, where appropriate, with a combination of both. Thus, the methods and apparatus of the disclosure, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the disclosure. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the disclosure, e.g., through the use of an application programming interface (API), reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

A remote desktop system is a computer system that maintains applications that can be remotely executed by client computer systems. Input is entered at a client computer system and transferred over a network (e.g., using protocols based on the International Telecommunications Union (ITU) T.120 family of protocols such as Remote Desktop Protocol (RDP)) to an application on a terminal server. The application processes the input as if the input were entered at the terminal server. The application generates output in response to the received input and the output is transferred over the network to the client computer system. The client computer system presents the output data. Thus, input is received and output presented at the client computer system, while processing actually occurs at the terminal server. A session can include a shell and a user interface such as a desktop, the subsystems that track mouse movement within the desktop, the subsystems that translate a mouse click on an icon into commands that effectuate an instance of a program, etc. In another example embodiment the session can include an application. In this example while an application is rendered, a desktop environment may still be generated and hidden from the user. It should be understood that the foregoing discussion is exemplary and that the presently disclosed subject matter may be implemented in various client/server environments and not limited to a particular terminal services product.

In most, if not all remote desktop environments, input data (entered at a client computer system) typically includes mouse and keyboard data representing commands to an application and output data (generated by an application at the terminal server) typically includes video data for display on a video output device. Many remote desktop environments also include functionality that extend to transfer other types of data.

Communications channels can be used to extend the RDP protocol by allowing plug-ins to transfer data over an RDP connection. Many such extensions exist. Features such as printer redirection, clipboard redirection, port redirection, etc., use communications channel technology. Thus, in addition to input and output data, there may be many communications channels that need to transfer data. Accordingly, there may be occasional requests to transfer output data and one or more channel requests to transfer other data contending for available network bandwidth.

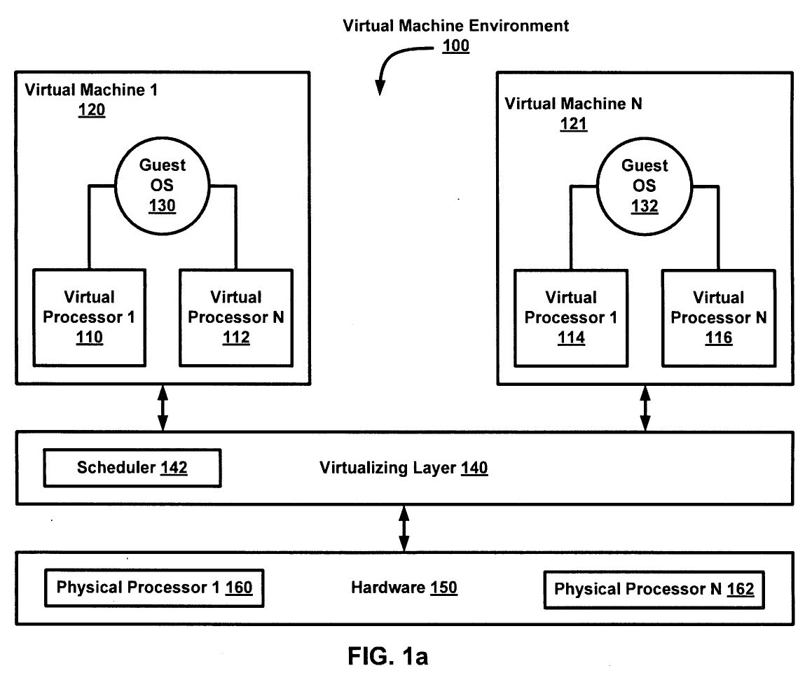

FIG. 2 shows an implementation 200 enabling terminal services. A TS client machine 202 and a TS 204 communicate using RDP. The TS client machine 202 runs a TS client process 206 that sends RDP input device data 208, such as for example keyboard data and mouse click data, to a TS session 210 that has been spawned on the TS and receives RDP display data 212, such as user interface graphics data. Generally, the TS client process 206 is a thin client process and most processing is provided on the TS 204.

FIG. 3 shows an implementation 300 enabling terminal services through a firewall 302. A remote TS client 304 connects to a terminal services gateway (TSG) 306 over a network 308. A Hypertext Transfer Protocol (HTTP) transport process 310 on the TS client and an HTTP process 312 on the TSG 306 facilitate communication through the firewall 302. The HTTP transport process 310 wraps data, such as Remote Procedure Call (RPC) data or RDP data, in HTTPS headers for the TSG 306. The TSG 306 may connect to the TS 314 over a socket connection 318 via a socket out process 316. Once the TS client 304 is authenticated and a connection is established, RDP data 320 may be passed back and forth between the TS client 304 and the TS 314.

FIG. 4 shows a generalized example of an implementation 400, wherein an existing remote procedure call/hypertext transport protocol (RPC/HTTP) proxy is leveraged, thereby providing a terminal services protocol, such as RDP, over an RPC/HTTP connection through a firewall 402. The architecture of the implementation illustrates that by wrapping the RDP protocol within RPC calls, an existing RPC-based proxy can be advantageously utilized. In particular, an RPC Transport Plug-In 404 on the TS client 406 wraps an RDP stream providing communication between the TS client 406 and the terminal server 408 within an RPC protocol. This facilitates utilization of an RPC-based proxy, thereby enabling firewall navigation. The RPC-based proxy 410, which may run in a user-mode on the TS, can forward received data to a socket listener 412, which may run in kernel-mode on the TS.

As discussed above, clients may use a remote protocol such as Remote Desktop Protocol (RDP) to connect to a resource using terminal services. When a remote desktop client connects to a terminal server via a terminal server gateway, the gateway may open a socket connection with the terminal server and redirect client traffic on the RDP port or a port dedicated to remote access services. The gateway may also perform certain gateway specific exchanges with the client using a terminal server gateway protocol transmitted over HTTPS.

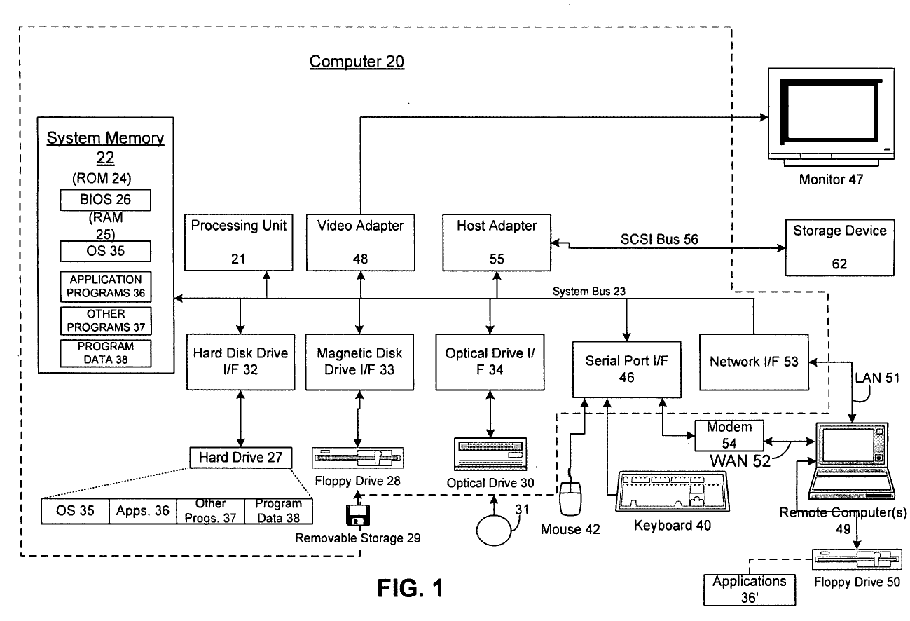

A virtual machine monitor, such as a hypervisor, is a program that creates virtual machines, each with virtualized hardware resources which may be backed by underlying physical hardware resources. FIG. 1a illustrates a virtual machine environment 100, with a plurality of virtual machines 120, 121, comprising a plurality of virtual processors 110, 112, 114, 116, and corresponding guest operating systems 130, 132. The virtual machines 120, 121 are maintained by a virtualizing layer 140 which may comprise of a scheduler 142 and other components (not shown), where the virtualizing layer 140 virtualizes hardware 150 for the plurality of virtual machines 120, 121. The plurality of virtual processors 110, 112, 114, 116 can be the virtual counterparts of underlying hardware physical processors 160, 162.

All of these variations for implementing the above mentioned partitions are just exemplary implementations, and nothing herein should be interpreted as limiting the disclosure to any particular virtualization aspect.

### Encoding Decoding of Data

Described herein is a system and method for encoding and decoding electronic information, and may include an encoding system with a tiling module that initially divides source image data into data tiles. A frame differencing module may then output only altered data tiles to various processing modules that convert the altered data tiles into corresponding tile components.

In an embodiment, a quantizer may perform a compression procedure upon the tile components to generate compressed data according to an adjustable quantization parameter. An adaptive entropy selector may then select one of a plurality of available entropy encoders to perform an entropy encoding procedure to thereby produce encoded data. The entropy encoder may also utilize a feedback loop to adjust the quantization parameter in light of current transmission bandwidth characteristics.

The process of encoding and decoding may generally use one or more methods and systems described in commonly assigned U.S. Pat. No. 7,460,725 entitled “System And Method For Effectively Encoding And Decoding Electronic Information,” hereby incorporated by reference in its entirety.

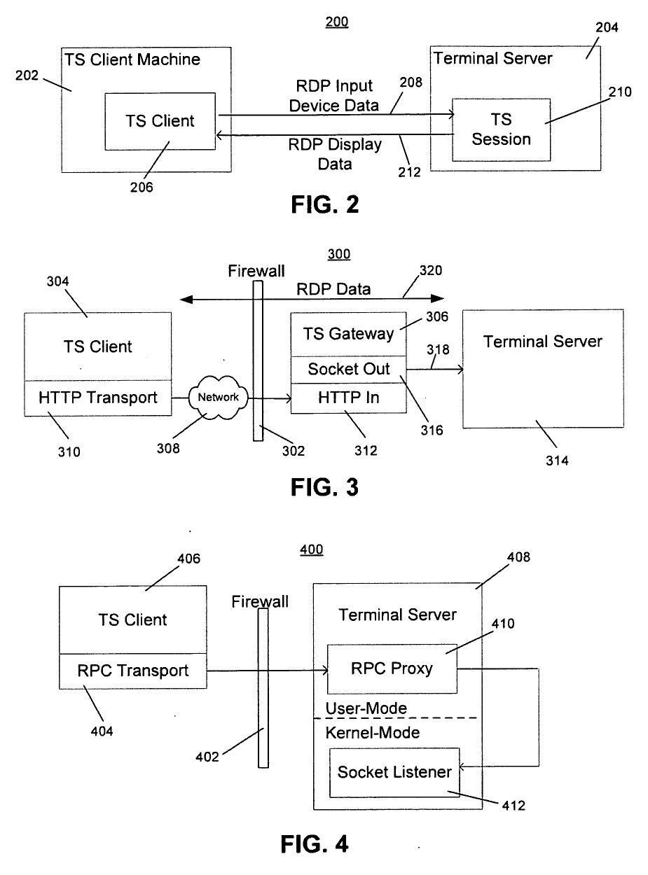

Referring to FIG. 5, a block diagram of an encoding system 500 is shown, in accordance with one embodiment of the present disclosure. In alternate embodiments, encoding system 500 may be implemented using components and configurations in addition to, or instead of, certain of those components and configurations discussed below in conjunction with the FIG. 5 embodiment. For example, in the FIG. 5 embodiment, encoding system 500 is discussed in the context of processing image data. However, in alternate embodiments, certain concepts and techniques from the present disclosure may be similarly utilized for processing other types of electronic information.

In the FIG. 5 embodiment, encoding system 500 may initially receive source image 501 as a frame of image data from any appropriate data source. A tiling module 502 then divides source image 501 into individual tiles that are implemented as contiguous sections of image data from source image 501. The individual tiles may be configured in any desired manner. For example, in certain embodiments, an individual tile may be implemented as a pixel array that is 128 pixels wide by 128 pixels high.

A frame differencing module 504 may compare the current source image 501, on a tile-by-tile basis, with similarly-located comparison tiles from a previous frame 505 of input image data. To reduce the total number of tiles that require encoding, frame differencing module 504 then outputs via path 506 only those altered tiles from the current source image 501 that are different from corresponding comparison tiles in previous frame 505.

DC shift module 507 may next add a constant DC voltage value to each pixel from the tiles that are output from frame differencing module 504. A color converter 508 also converts each of the tiles from a first color format to a second color format that is appropriate for further processing by encoding system 500. For example, in certain embodiments, source image 501 may initially be received in an RGB format that color converter 508 then responsively converts into a corresponding YUV format.

A discrete wavelet transform module (DWT) 510 may perform a known discrete wavelet transform procedure to transform the individual YUV components of the tiles into corresponding YUV tile subbands. Additional details of discrete wavelet transforms are further discussed in “The JPEG 2000 Still Image Compression Standard,” by Athanassios Skodras et al., published in IEEE Signal Processing Magazine, September 2001.

A quantizer module 511 may next perform a quantization procedure by utilizing appropriate quantization techniques to compress the tile subbands. In the FIG. 5 embodiment, quantizer 511 may produce compressed image data 512 by reducing the bit rate of the tiles according to a particular compression ratio that may be specified by an adaptive quantization parameter 515 received via a feedback loop from entropy encoder 513.

Entropy encoder 513 may perform an entropy encoding procedure to generate encoded data 514. In certain embodiments, the entropy encoding procedure further reduces the bit rate of the compressed image data by substituting appropriate codes for corresponding bit patterns in the compressed image data received from quantizer 511.

In certain alternate embodiments, a System-On-Chip (SOC) device may include encoding system 500 in conjunction with a Central Processing Unit (CPU) and/or a Graphics Processing Unit (GPU). The Graphics Processing Unit may programmatically perform a Discrete Wavelet Transform analysis function to feed subbands to a quantizer. The Graphics Processing Unit may also include Context-Adaptive Binary Arithmetic Coding (CABAC) encoders for generating encoded data from the compressed data received from the quantizer.

This form of integration is efficient because the data for encoding is available to the Graphics Processing Unit, and does not have to be provided by Direct Memory Access techniques into memory of the encoding systems for processing. A corresponding decoding system or System-On-Chip may include other processing elements including a Graphics Processing Unit for performing traditional graphics processing operations such as Bit Block Transfers (BitBlit), up and down scaling, line drawing, as well as supporting a robust windowing system.

In the FIG. 5 embodiment, encoding system 500 is disclosed and discussed as being implemented primarily as hardware circuitry. In certain embodiments, encoding system 500 may be implemented as a single integrated-circuit device. However, in alternate embodiments, some or all of the functions of the present disclosure may be performed by appropriate software instructions that are executed to effectively perform various functions discussed herein.

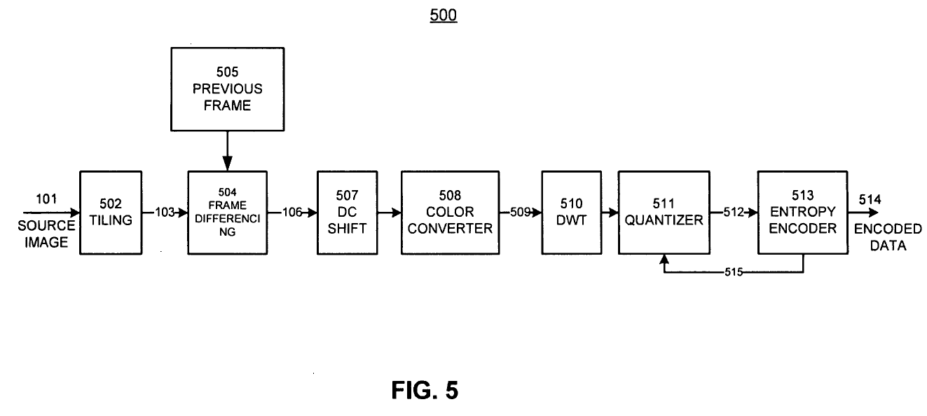

Referring now to FIG. 6, a block diagram of a decoding system 600 is shown, in accordance with one embodiment of the present disclosure. In alternate embodiments, decoding system 600 may be implemented using components and configurations in addition to, or instead of, certain of those components and configurations discussed in conjunction with the FIG. 6 embodiment. For example, decoding system 600 is discussed in the context of processing image data. However, in alternate embodiments, certain concepts and techniques from the present disclosure may be similarly utilized for processing other types of electronic information.

In the FIG. 6 embodiment, decoding system 600 may initially receive encoded data 514 that is provided from one or more data sources in any appropriate encoding format. An entropy decoder 602 may perform an entropy decoding procedure to convert encoded data 514 into compressed image data 603. In certain embodiments, the entropy decoding procedure increases the bit rate of encoded data 514 by substituting appropriate bit patterns for corresponding codes in the encoded data 514 to produce compressed image data 603 in a YUV format.

A dequantizer module 604 next performs a dequantization procedure by utilizing appropriate dequantization techniques for decompressing the compressed image data 603 to produce various corresponding tile subbands. For example, in certain embodiments, dequantizer 604 produces the tile subbands by performing dequantization based upon the quantization setting of quantizer 511 during encoding. An inverse discrete wavelet transform module (inverse DWT) 605 may perform a known inverse discrete wavelet transform procedure to reverse a corresponding discrete wavelet transform procedure by converting individual tile subbands into corresponding individual tiles that are output on path 606.

A color converter 607 may then convert each of the individual tiles from a first color format to a second color format for further processing by decoding system 600. For example, in certain embodiments, the individual tiles received by color converter 607 may be converted from a YUV format into a corresponding RGB format. A DC shift circuit 608 may next subtract a predetermined constant DC voltage value from each pixel of the tiles that are output from color converter 607.

A frame reconstructor 610 may then compare the current frame of image data, on a tile-by-tile basis, with similarly-located comparison tiles from a previous frame 611 of image data to reconstruct the current frame with the total number of tiles that were previously subject to a frame differencing procedure by frame differencing module 104 of FIG. 5. Frame reconstructor 610 may then output the reconstructed image 612 for utilization by any appropriate entity.

Furthermore, in certain alternate embodiments, decoding system 600 may be implemented as part of a System-On-Chip (SOC) device in which a CABAC decoder of decoding system 600 is shared by inverse DWT 605 and an H.264 Integer Transform decoding system. The CABAC decoder may process data in an H.264 mode and in an enhanced Discrete Wavelet Transform mode under program control. The CABAC encoder may operate on a wavelet-based tile in Discrete Wavelet Transform mode, and may process a separate video bit stream for the H.264 mode.

In the FIG. 6 embodiment, decoding system 600 is disclosed and discussed as being implemented primarily as hardware circuitry. In certain embodiments, decoding system 600 may be implemented as a single integrated-circuit device. However, in alternate embodiments, some or all of the functions of the present disclosure may be performed by appropriate software instructions that are executed to effectively perform various functions discussed herein.

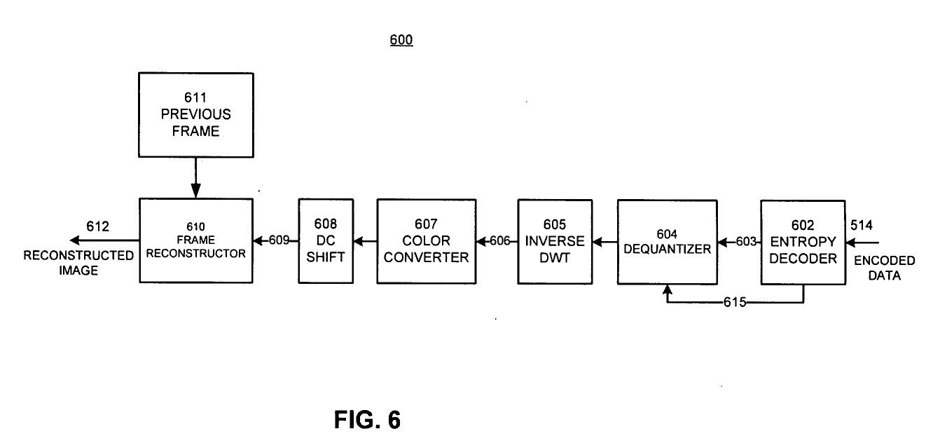

Referring now to FIG. 7, a diagram illustrating a frame differencing procedure is shown, in accordance with one embodiment of the present disclosure. The embodiments depicted in FIGS. 7 and following are presented for purposes of illustration, and in alternate embodiments, the present disclosure may readily perform frame differencing procedures using techniques and configurations in addition to, or instead of, certain of those techniques and configurations discussed in conjunction with the depicted embodiments.

In the FIG. 7 embodiment, frame differencing module 504 may store a previous frame 505 of image data that has been segmented into a series of discrete tiles 1-20 by tiling module 502 (FIG. 5). In the FIG. 7 embodiment, frame differencing module 504 performs the frame differencing procedure using any appropriate techniques for comparing corresponding tiles of previous frame 505 and current frame 705 to determine whether the pixels in any of the compared tiles have been altered.

In the FIG. 7 drawing, for purposes of illustration, altered tiles in current frame 705 are indicated with the letter “n” following the tile number. For example, current frame 705 includes altered tiles 3n, 7n, 8n, 9n, and 13n. Instead of processing all current frames 705, frame differencing module 504 efficiently outputs via path 506 only those altered tiles that are different from corresponding tiles from previous frame 505. In the FIG. 7 embodiment, frame differencing module 504 outputs an altered frame 707 that is populated only with altered tiles 3n, 7n, 8n, 9n, and 13n. If a current frame 705 exhibits no changed tiles with respect to previous frame 505, then the unaltered current frame 705 is not output by frame differencing module 504. The foregoing frame differencing procedure may significantly reduce the processing requirements for encoding system 500 (FIG. 5) and decoding system 600 (FIG. 6).

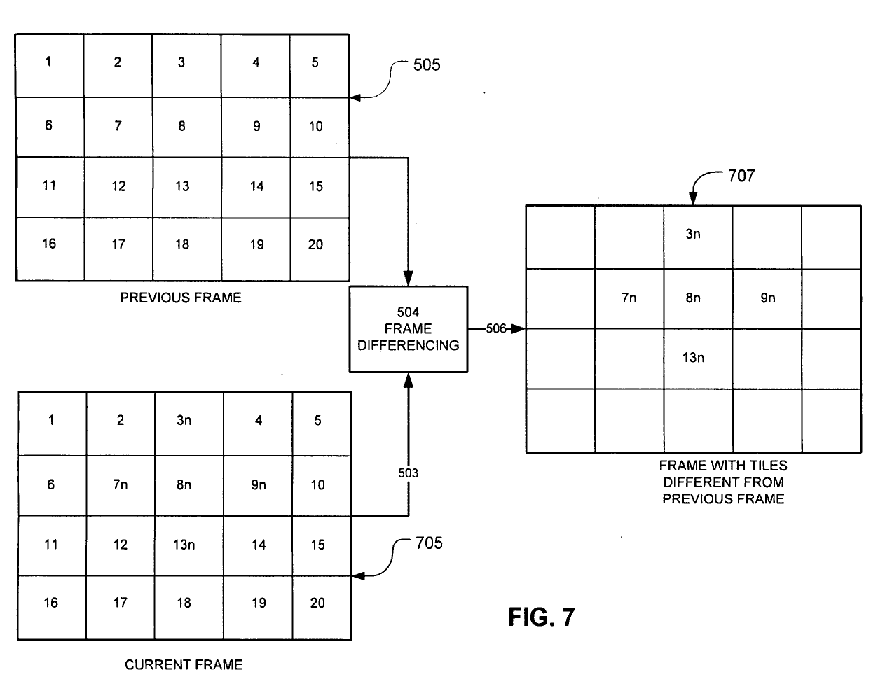

Referring now to FIG. 8, a diagram illustrating a frame reconstruction procedure is shown, in accordance with one embodiment of the present disclosure. In the FIG. 8 embodiment, frame reconstructor 610 may store a previous frame 611 of image data that is segmented into a series of discrete tiles 1-20. Frame reconstructor module 610 may perform the frame reconstruction procedure using appropriate techniques for comparing corresponding tiles of previous frame 611 and a received frame 707 to determine whether the pixels in any of the compared tiles have been altered. Received frame 707 preferably is the same or similar to the “frame with tiles different from previous frame” that is shown as the output of frame differencing module 504 in FIG. 6.

In the FIG. 8 drawing, for purposes of illustration, altered tiles in frame 707 are indicated with the letter “n” following the tile number. For example, frame 707 includes altered tiles 3n, 7n, 8n, 9n, and 13n. To reverse the frame differencing procedure described in FIG. 7, frame reconstructor 610 may utilizes any number of appropriate techniques to reconstruct the original current frame 705 that was initially processed by frame differencing module 504 in FIG. 7. For example, frame reconstructor 610 may output a current frame 705 that is populated with the altered tiles 3n, 7n, 8n, 9n, and 13n from frame 707, and the remaining unaltered tiles 1-2, 4-6, 10-12, and 14-20 from previous frame 611. The foregoing frame reconstruction procedure thus supports the prior frame differencing procedure of FIG. 7 to provide significantly reduced processing requirements for encoding system 500 (FIG. 5) and decoding system 600 (FIG. 6).

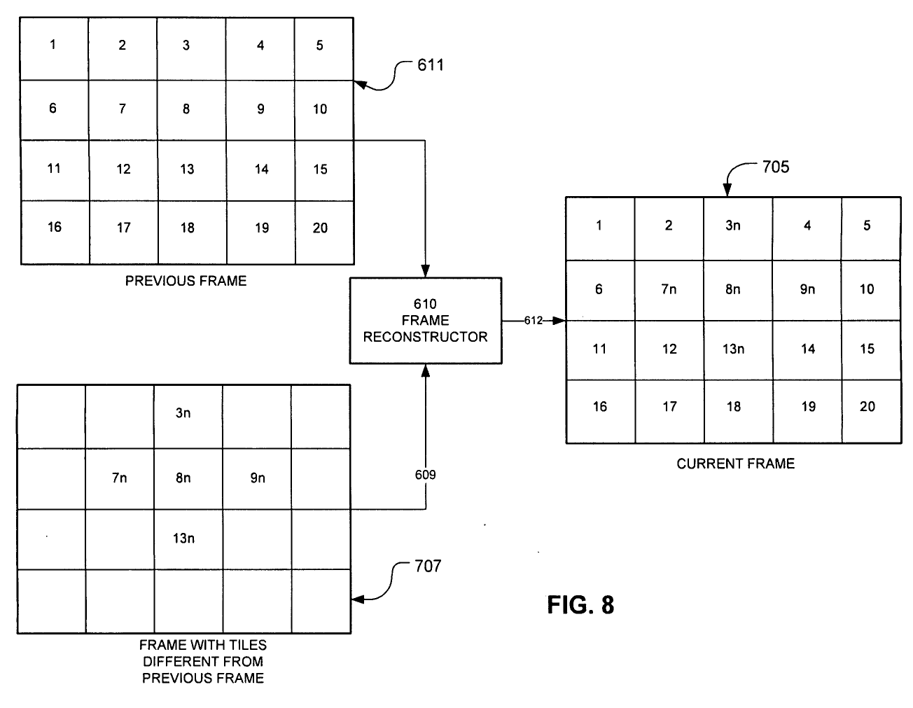

Referring now to FIG. 9, a block diagram for the FIG. 5 entropy encoder 513 is shown, in accordance with one embodiment of the present disclosure. In alternate embodiments, entropy encoder 513 may be implemented using components and configurations in addition to, or instead of, certain of those components and configurations discussed in conjunction with the FIG. 9 embodiment.

In the FIG. 9 embodiment, entropy encoder 513 may include an adaptive entropy selector 912 (including a rate controller), a Context-Based Adaptive Binary Arithmetic Coding (CABAC) Encoder 916, and a Run-Length Encoding encoder (RLE) 920. CABAC encoder 916 may be selected to perform an entropy encoding procedure in accordance with a known H.264 CABAC standard. Further details about the H.264 CABAC encoding process are discussed in “Context-Based Adaptive Binary Arithmetic Coding,” by Marpe, Detlev, et al., in the H.264/AVC Video Compression Standard, IEEE Transactions On Circuits And Systems For Video Technology, Vol. 13, No. 7, July 2003.

Entropy encoder 513 may alternately select and activate RLE encoder 920 to perform entropy encoding procedures in accordance with certain known run-length encoding techniques. Further details about various types of run-length encoding techniques may be found and reviewed on-line at the following Internet web page address: http://en.wikipedia.org/wiki/Run-length_encoding.

The CABAC encoder 916 is typically implemented as one or more hardware circuits, while RLE encoder 920 is typically implemented to perform entropy encoding procedures in response to the execution of entropy encoding software instructions.

In the FIG. 9 embodiment, adaptive entropy selector 912 may initially receive compressed data 512 from quantizer 511 of FIG. 5. Adaptive entropy selector 912 may sense currently available transmission bandwidth and memory resources for entropy encoder 513. Because certain versions of encoding system 500 and/or decoding system 200 may not support CABAC encoding and/or decoding, adaptive entropy selector 912 may also determine whether CABAC encoders/decoders are available for performing corresponding entropy encoding and/or decoding processes.

Based upon the foregoing encoding selection criteria, adaptive entropy selector 912 may be configured to select either CABAC encoder 916 or RLE encoder 920 to perform the current entropy encoding procedure. For example, if available transmission bandwidth and memory resources are relatively low, adaptive entropy selector 912 may select CABAC encoder 916. Similarly, if a higher degree of compression is required, adaptive entropy selector 912 may select CABAC encoder 916. Alternately, if CABAC encoding is not currently supported, adaptive entropy selector 912 may select RLE encoder 920. Similarly, if transmission bandwidth and memory resources are sufficiently available, then adaptive entropy selector 912 may consider selecting RLE encoder 920 for performing the entropy encoding process.

Adaptive entropy selector 912 may include a rate controller that adjusts and provides an adaptive quantization parameter 515 via a feedback loop to quantizer 511 (FIG. 5) to produce compressed image data 512 by altering the bit rate of compressed image data 512 according to a particular compression ratio that is specified by the adaptive quantization parameter 515. The rate controller of adaptive entropy selector 912 may determine picture quality characteristics of encoded data 514 by utilizing various appropriate criteria or techniques.

The rate controller of adaptive entropy selector 912 may then adjust adaptive quantization parameter 515 to decrease the amount of compression if encoded data 514 exhibits unacceptable picture quality, or if bandwidth characteristics of the downstream channel are insufficient. Conversely, the rate controller may adjust adaptive quantization parameter 515 to increase the amount of compression if the picture quality of encoded data 514 is not particularly critical. In addition, the rate controller may adjust adaptive quantization parameter 515 to decrease the amount of compression in compressed image data 512 when available memory and/or transmission bandwidth becomes relatively scarce. Conversely, the rate controller may adjust adaptive quantization parameter 515 to increase compression levels of compressed image data 512 when available memory and/or transmission bandwidth is sufficiently available and improved picture quality is desired.

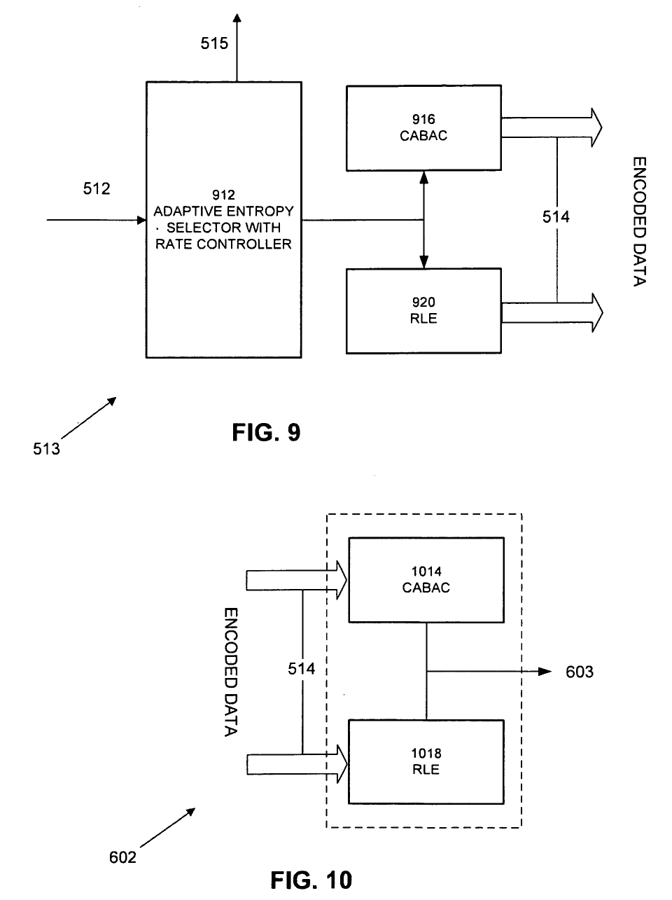

Referring now to FIG. 10, a block diagram for the FIG. 6 entropy decoder 602 is shown, in accordance with one embodiment of the present disclosure. In the FIG. 10 embodiment, entropy decoder 602 may include a CABAC decoder 1014 and an RLE decoder 1018. CABAC decoder 1014 may be selected to perform known entropy decoding procedures to effectively reverse the entropy encoding procedure performed by CABAC encoder 516 of FIG. 9. In certain embodiments, CABAC decoder 1014 may be selected to perform an entropy decoding procedure in accordance with a known H.264 CABAC standard that is discussed above in conjunction with FIG. 9.

Alternately, RLE decoder 920 may be selected to perform known entropy decoding procedures to effectively reverse the entropy encoding procedure performed by RLE encoder 920 of FIG. 9. In certain embodiments, entropy decoder 602 may select RLE decoder 1018 to perform appropriate entropy decoding procedures in accordance with various known run-length decoding standards that are discussed above in conjunction with RLE encoder 920 of FIG. 9.

Entropy encoder 602 may initially receive encoded data 514 from any appropriate data source. In response, entropy encoder 602 may analyze encoded data 514 to determine whether encoded data 514 is configured in a CABAC-encoded format or in an RLE-encoded format. Entropy encoder 602 may then activate either CABAC decoder 1014 or RLE decoder 1018 to perform an entropy decoder procedure, depending upon the type of encoding format of the encoded data 514.

For example, if encoded data 514 is received in a CABAC-encoded format, then entropy decoder may 602 utilize CABAC decoder 1014 to decode encoded data 514 to provide corresponding compressed image data 603 to dequantizer 204 (FIG. 6). Alternately, if encoded data 514 is received in an RLE-encoded format, then entropy decoder 602 may utilize RLE decoder 920 to decode encoded data 514 to provide corresponding compressed image data 603 to dequantizer 204.

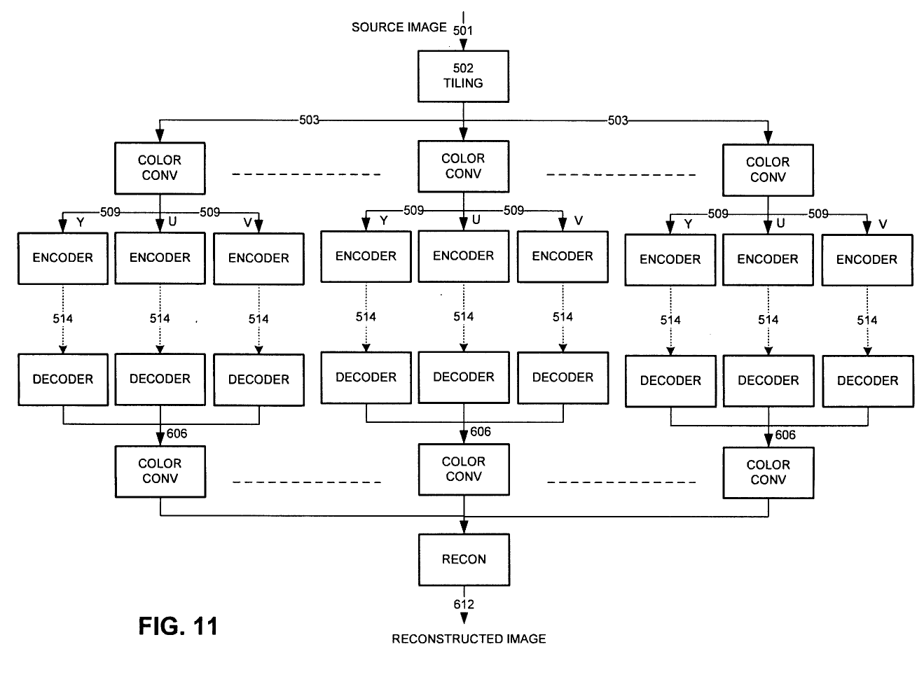

Referring now to FIG. 11, a block diagram for a multiple encoder-decoder architecture is shown, in accordance with one embodiment of the present disclosure. In the FIG. 11 embodiment, a tiling module 502 initially receives a source image 501 as a frame of image data from any appropriate data source. Tiling module 502 then divides source image 501 into individual tiles that are preferably implemented as contiguous sections of image data from source image 501. The individual tiles 503 are each sent to one of a series of different color converters that each convert respective received tiles from a first color format to a second color format. For example, in certain embodiments, source image 501 may initially be received in an RGB format which the color converters responsively convert into corresponding YUV components 509 on a tile-by-tile basis.

A series of encoders are shown configured in parallel to concurrently encode the YUV components 509. These encoders may be implemented in any appropriate manner. For example, in certain embodiments, each of the encoders may be implemented to include DWT 510, quantizer 511, and entropy encoder 513 from the FIG. 1 embodiment of encoding system 500. Each of the YUV components 509 are separately provided to a different one of the parallel encoders for concurrent encoding to significantly improve throughput characteristics of the encoding process. Each of the YUV components 509 may then be concurrently output from a respective one of the parallel encoders as encoded data 514.

In the FIG. 11 embodiment, a series of decoders are shown configured in parallel to concurrently decode respective components of encoded data 514. These decoders may be implemented in any appropriate manner. For example, in certain embodiments, each of the parallel decoders may be implemented to include entropy decoder 602, dequantizer 504, and inverse DWT 605 from the FIG. 2 embodiment of decoding system 600. Each of the components of encoded data 514 are separately provided to a different one of the parallel decoders for concurrent decoding to significantly improve throughput characteristics of the decoding process.

Each of decoders may then concurrently output a respective one of the decoded YUV components 606 to a corresponding color converter which converts and combines the YUV components 606 into a composite image (such as a composite RGB image). A frame reconstructor (RECON) may then provide a reconstructed image 612 to any appropriate image destination.

The multiple encoder/decoder architecture is shown with a matching number of encoders and decoders. However, in alternate embodiments, encoder/decoder architectures are also contemplated with non-matching numbers of encoders and decoders. For example, a server computer may require a larger number to encoders to efficiently process a large amount of data for use by separate client computers that each require a relatively reduced numbers of decoders.

In addition, multiple encoder/decoder architectures may similarly be utilized to separately encode and/or decode individual images in a parallel manner for utilization by different data destinations. Furthermore, in certain embodiments, an individual encoder or decoder may be implemented with a plurality of entropy encoders that are configured in parallel to support a single encoding system. For example, the encoding system 500 of FIG. 5 and/or the decoding system 600 of FIG. 6 may be implemented with a plurality of appropriate CABAC encoders 516 or CABAC decoders 614 configured in parallel so that other system components need not wait in an idle state for completion of lengthy entropy encoding or decoding procedures.

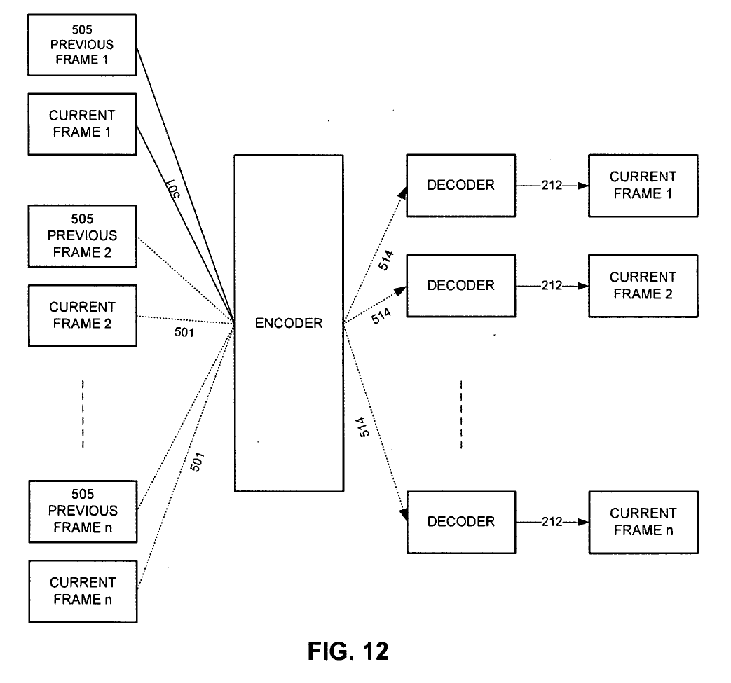

Referring now to FIG. 12, a block diagram illustrating a multiple image encoding/decoding procedure is shown, in accordance with one embodiment of the present disclosure. In the FIG. 12 embodiment, a single encoder is shown concurrently encoding an image 1 through an image n, and providing the respective encoded images to appropriate decoders. The encoder may be implemented in any effective manner. For example, in certain embodiments, the FIG. 12 encoder may include, but is not limited to, any of the components shown in the encoding system 500 of FIG. 1.

The encoder stores previous frames 1 through n (505) from respective corresponding images. The FIG. 12 encoder also receives current frames 1 through n of source images 501 from any appropriate destination(s). The FIG. 12 encoder then concurrently processes the current frames 501 using any appropriate techniques to generate corresponding encoded data 514. For example, in certain embodiments, the FIG. 12 encoder utilizes encoding techniques that are the same as, or similar to, those encoding techniques discussed above in conjunction with FIGS. 5, 7, and 9.

In the FIG. 12 embodiment, the encoder may then provide the individual frames of encoded data 514 to respective decoders that are configured in parallel to concurrently decode corresponding frames of encoded data 514. These decoders may be implemented in any appropriate manner. For example, in certain embodiments, the FIG. 12 decoders may each include, but are not limited to, any of the components shown in decoding system 600 of FIG. 2.

The FIG. 12 decoders may then concurrently process the encoded data 514 using an appropriate technique to generate corresponding current frames 1 through n of reconstructed images 612. For example, in certain embodiments, the FIG. 12 decoders utilize decoding techniques that are the same as, or similar to, those decoding techniques discussed above in conjunction with FIGS. 6, 8, and 10. In the FIG. 12 embodiment, the reconstructed images 612 may then be provided to any appropriate image destination.

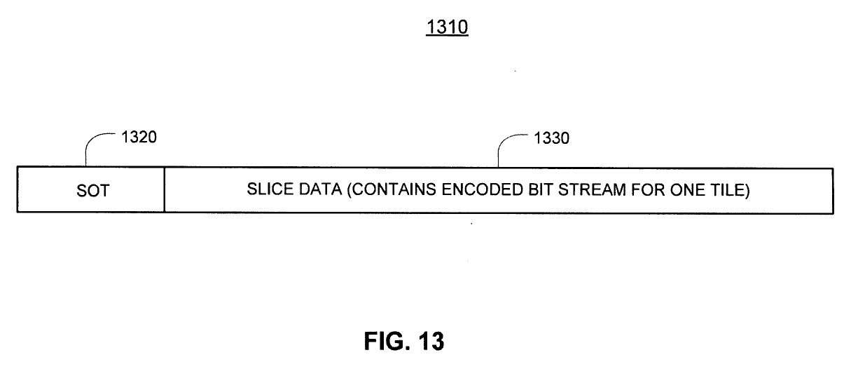

Referring now to FIG. 13, a diagram for tile data 1310 is shown, in accordance with one embodiment of the present disclosure. In the FIG. 13 embodiment, tile data 1310 includes a Start Of Tile (SOT) header 1320 and slice data 1330. The FIG. 13 embodiment is presented for purposes of illustration, and in alternate embodiments, tile data 1310 may be implemented using components and configurations in addition to, or instead of, certain of those components and configurations discussed in conjunction with the FIG. 13 embodiment.

The FIG. 13 embodiment illustrates the data format for storing or transmitting encoded data 514 for each tile. The start of tile header (SOT) 1320 consists of various different selectable parameters that are used to reconstruct the tile and embed the tile into to a current frame of image data. For example the SOT 1320 may include quantization parameters for various subbands, a length of an associated encoded information, and offset values to facilitate decoding procedures. The SOT 1320 may be followed by the slice data 1330 that may include an encoded bit stream corresponding to one associated tile. In the FIG. 13 embodiment, the slice data may be encoded in any appropriate format. For example, in certain embodiments, slice data may be encoded either by the CABAC encoder 916 or by the RLE encoder 920 discussed above in conjunction with FIG. 9.

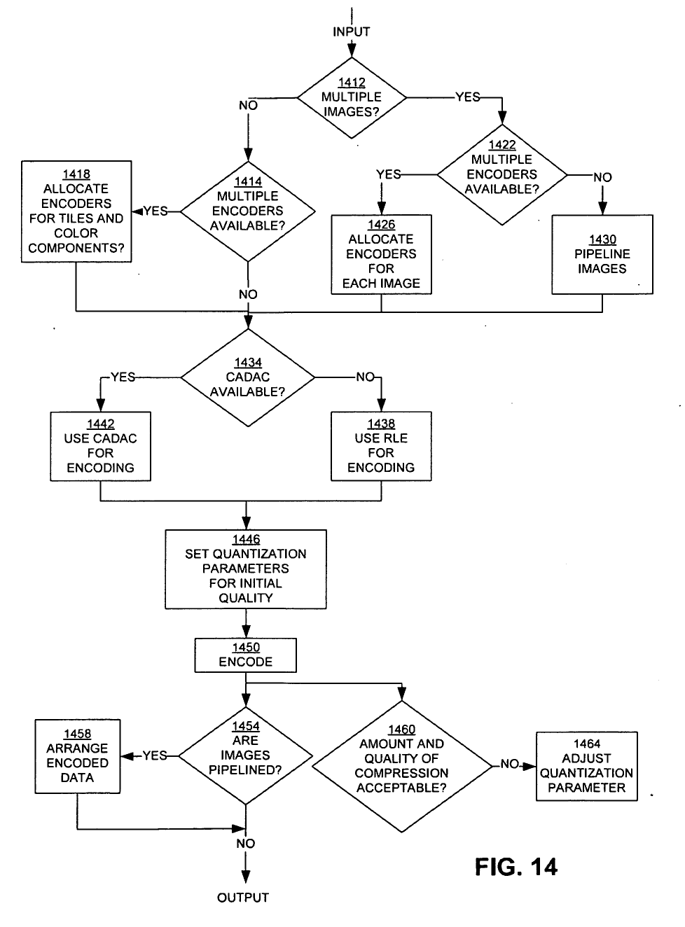

Referring now to FIG. 14, an exemplary operational procedure for performing an encoding procedure is shown, in accordance with one embodiment of the present disclosure. In the FIG. 14 embodiment, in operation 1412, an encoding system 500 receives input data, and responsively determines whether the input data includes multiple images. If only a single image source is being received, then in operation 1414, encoding system 500 determines whether multiple encoders are available for processing the image. If multiple encoders are available, then in operation 1418, encoding system 500 allocates the encoders to separately and concurrently process the individual tiles of the different color components in a parallel manner.

Alternately, if multiple images are received, then in operation 1422, encoding system 500 determines whether multiple encoders are available for processing the images. If multiple encoders are available, then in operation 1426, encoding system 500 allocates the encoders to separately and concurrently process the multiple images in a parallel manner. If multiple encoders are not available, then in operation 1430, encoding system 500 performs a pipelining procedure for passing the multiple images through the encoding process.

In operation 1434, encoding system 500 determines whether CABAC encoding/decoding is supported. If a CABAC encoding/decoding is available, then in operation 1442, encoding system 500 utilizes the CABAC encoder 916 to perform the entropy encoding procedure. However, if a CABAC encoding/decoding is not available, then in operation 1438, encoding system 500 utilizes a RLE encoder 920 to perform the entropy encoding procedure.

In operation 1446, encoding system 500 sets a quantization parameter at an initial image quality level that corresponds to a particular compression ratio 515 of a quantizer 511 (FIG. 5). Then, in operation 1450, encoding system 500 encodes the image(s) in a pre-determined encoding format. In operation 1454, encoding system 500 determines whether the images are pipelined. If the images are not pipelined, then encoding system 500 outputs the encoded data 514 to an appropriate data destination. Alternately, if the images are pipelined, in operation 1458, encoding system 500 arranges the encoded data 1458 before outputting the encoded data 514 to an appropriate data destination.

In operation 1460, encoding system 500 determines whether the compression amount and quality of the output images are acceptable. If the amount and quality of compression are not acceptable according to pre-defined criteria, then in operation 1464, encoding system 500 dynamically utilizes a feedback loop to adjust the quantization parameter 515 for altering the compression ratio of quantizer 511 to thereby change the amount and quality of the encoding compression.

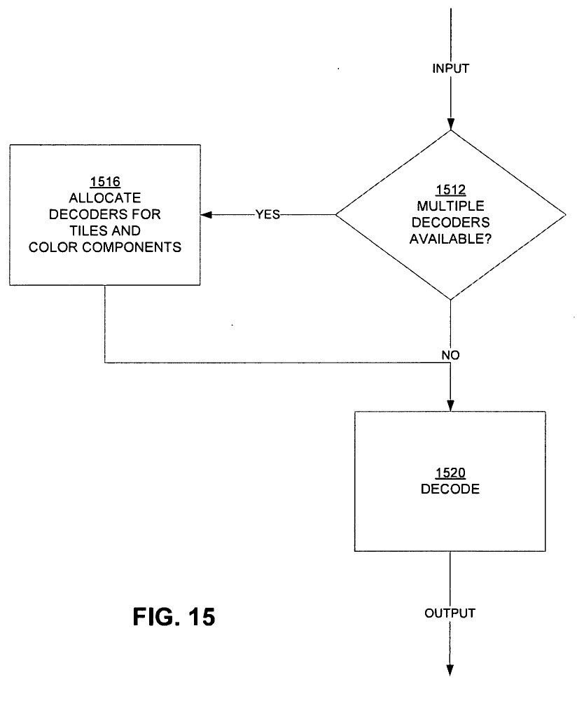

Referring now to FIG. 15, an exemplary operational procedure for performing a decoding procedure is shown, in accordance with one embodiment of the present disclosure. In the FIG. 15 embodiment, a decoding system 600 initially receives input data in the form of encoded data 914. Then in operation 1512, decoding system 600 determines whether multiple decoders are available for processing the encoded data 514. If multiple encoders are available, then in operation 1516, decoding system 600 allocates the decoders to separately and concurrently process the individual tiles of the different color components in a parallel manner. In operation 1520, decoding system 600 next decodes the image data in a pre-determined manner to produce a reconstructed image 612. Decoding system 600 then outputs the reconstructed image 612 to any appropriate data destination(s).

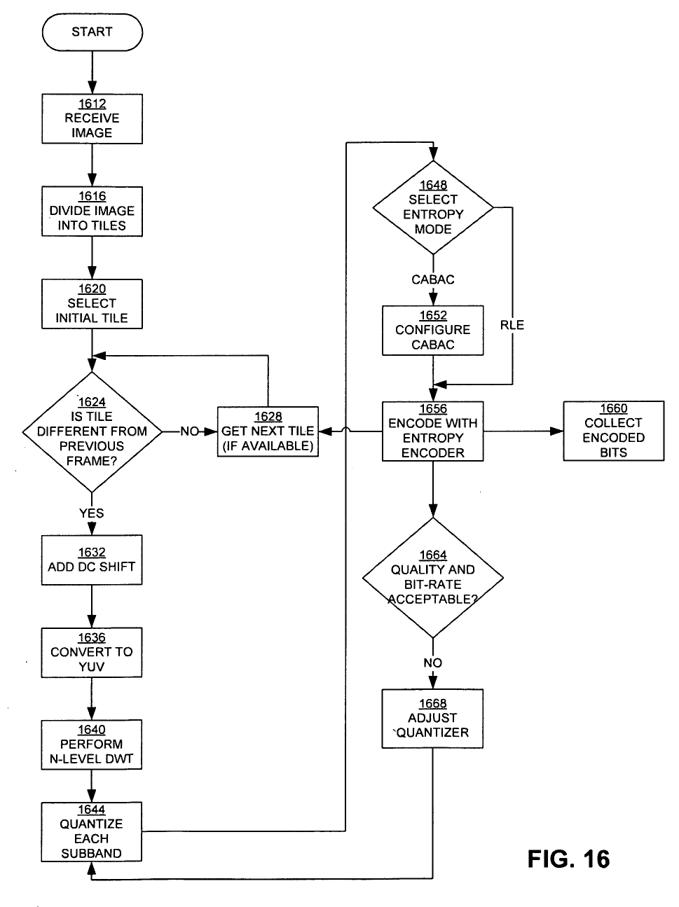

Referring now to FIG. 16, an exemplary operational procedure for performing an encoding procedure is shown, in accordance with one embodiment of the present disclosure. In the FIG. 16 embodiment, in operation 1612, an encoding system 500 initially receives a source image 501 from any appropriate data source. The source image 501 may be configured according to any desired data format. For example, in certain embodiments, the source image 501 may be implemented as an array of digital picture elements (pixels) in a known RGB format. In operation 1616, encoding system 500 utilizes a tiling module 502 to divide the source image 501 into individual tiles that are implemented as contiguous sections of image data from the source image 501.

In operation 1620, encoding system 500 selects a current tile from the source image 501. Then in operation 1624, a frame differencing module 504 compares the current tile to a corresponding comparison tile from a previous frame 505 to determine whether the current tile has been altered with respect to the comparison tile from the immediately preceding frame 505. If the pixels in the current tile have not been altered, then frame differencing module 504 does not output the current tile. Instead, in operation 1628, frame differencing module 504 accesses the next tile (if available) from source image 501, and the FIG. 16 process returns to repeat foregoing operation 1624.

However, in operation 1624, if one or more pixels in the current tile have been altered, then frame differencing module 504 outputs the corresponding tile to a DC shift module 507 that adds a constant DC voltage value to each pixel from the tiles that are output from frame differencing module 504. In operation 1636, a color converter 508 converts each of the altered tiles from a first color format to a second color format that is appropriate for further processing by encoding system 500. For example, in certain embodiments, source image 501 may initially be received in an RGB format which color converter 508 responsively converts into a corresponding YUV format.

In the FIG. 16 embodiment, a discrete wavelet transform module (DWT) 510 performs a known discrete wavelet transform procedure (DWT) to transform the individual color components of the tiles into corresponding color subbands. A quantizer module 511 next performs a quantization procedure by utilizing appropriate quantization techniques to compress the color subbands. Quantizer 511 produces compressed image data 512 by reducing the bit rate of the color subbands according to a particular compression ratio that is specified by an adaptive quantization parameter 515.

In operation 1648, an adaptive entropy selector 512 next selects an appropriate entropy mode (either CABAC mode or RLE mode) for performing an entropy encoding procedure based upon certain predetermined encoding mode selection criteria. If CABAC mode is selected, then in operation 1652, encoding system 500 advantageously performs a CABAC configuration procedure that defines certain specific configuration parameters for operating a CABAC encoder 516 to optimally process the compressing image data 512 received from quantizer 511.

In operation 1656, an entropy encoder 513 performs an entropy encoding procedure upon the compressed data 512 by utilizing the entropy mode (either CABAC mode or RLE mode) that was selected in foregoing operation 1648. In operation 1660, encoding system 500 may then collect the encoded data 514 for providing to any appropriate data destination(s). At this point, the FIG. 16 process may be repeated for additional tiles by returning to operation 1628, where frame differencing module 504 accesses the next tile from source image 501 (if any unprocessed tiles remain).

In operation 1364, encoding system 500 may further perform a bit-rate control procedure by initially determining whether the quality and bit-rate of encoded data 514 are acceptable in light of one or more pre-defined image assessment criteria. In operation 1664, if encoding system 500 determines that the quality and bit-rate of encoded data 514 are not acceptable, then in operation 1668, a bit rate controller of entropy encoder 513 provides an adaptive quantization parameter 515 via a feedback loop to quantizer 511 to alter the bit rate of compressed image data 514 according to a particular compression ratio that is specified by the adaptive quantization parameter 515.

### Concurrent Encoding/Decoding of Data

As described above, a graphics bitmap may be divided into tiles. Furthermore, when a tile is sent from the server to the client, the tile data may be encoded to reduce the amount of data sent over the network. It can be seen that the encoding/decoding process involves a series of operations that are preferably performed at a rate that supports the continuous reception/capture of frames and generation of graphics on the client side such that the user can be provided a high quality and timely display experience. Some of the described encoding/decoding operations may be performed on the entire tile, e.g. discrete wavelet transformation and quantization. The discrete wavelet transformation process involves repeated operations and feeding the results of one stage into the next stage.

For example, a 128×128 tile may be transformed into four 64×64 subtiles that may represent combinations of high and/or low frequency components or subbands. Each of these four subtiles may then be transformed into four 32×32 subtiles, each of which may then be transformed into four 16×16 subtiles. At each intermediate level, it is preferable that the output of one stage be immediately fed into the next stage without the step of storing the result. Each of the resulting subtiles may then be directly quantized and entropy encoded. In a hardware implementation, such operations may be performed efficiently and quickly. In general, however, entropy encoding, which is typically at the last stage of the encoding process described above, is slower in throughput and may be more processor intensive. Furthermore, processing requirements tend to increase as a function of the magnitude of the data coefficients produced during the encoding phase. It is desirable to preserve the coefficient values without any loss of fidelity. However, the storing of intermediate values is not desired because of the time required to perform I/O operations and the amount of memory required. The entire intermediate result would need to be stored before proceeding to the succeeding processing stage, which may result in performance penalties due to the movement into and out of memory as well as the number of processing cycles needed.

Accordingly, the above algorithms may be adapted such that the tiles or subtiles are divided into two or more segments that may be independently processed. In various embodiments, the segments may comprise “slices” of the tile or subtile. In one embodiment, a tile or subtile may be logically divided into four slices of equal size. Each slice of the tile data may then be independently and/or concurrently processed. Depending on the specific format used, the slicing process may be performed for each image component. For example, if a YUV format is used, then the slicing process may be performed for each of the three YUV components or their transformed subtiles.

The processing may further be implemented in software, custom hardware, or both. When the slice processing is implemented in software, the programming may utilize the multi-core CPUs that are typically used in many computing systems. The program may be thus be written such that each core processes a slice of the tile data. If a tile is divided into four slices and the slices are processed on four CPU cores, the total processing time can be reduced to about a quarter of the time it would take to process the entire tile without slicing.

When the slice processing is implemented in hardware, the hardware may be designed to instantiate 1, 2 or 4 or more instances of a slice processing engine. In an embodiment, the slice processing engine may implement an encoder slice engine that performs entropy encoding on a slice of tile data. An arbiter function may also be provided that collects the data from a prior stage, logically divide the data into slices, and distribute the data slices to the slice engines.

On the client side, one or more decoder slice engines may perform the reverse of entropy encoding on a received slice of encoded tile data. The output of each decoder slice engine may then be combined and then passed to the next processing stage which may process the combined data tile. For example, four entropy decoder slice engines may receive four slices for concurrent processing. The output of each concurrent process may then be logically combined and passed to the de-quantization phase.

As mentioned, the data slices are independent and may be processed independently. In an embodiment, each slice may be associated with different areas of memory. Because the output of a compression stage requires variable storage space, it may not be possible to plan in advance the amount of memory that should be reserved for a process. The data may thus be placed into different areas of memory during processing. Upon completion of processing, the processed slices may be concatenated to produce the complete result.

The preferred number of slices may be determined according to the specific needs of the system and the processing techniques used. A trade off can be determined between the number of processors and the size of the data. For example, if the tile size is 128×128 and a discrete wavelet transformation is used, 16×16 subtiles will be produced after three intermediate stages. The 16×16 subtile may then be divided into four 16×4 slices that may be processed by four slice engines. Using two slice engines with 16×8 slices will not likely provide the improvement in throughput that is desired, and eight slices with 16×2 slices will not likely provide an efficient balance between the increased number of processes and a notable improvement in throughput.

While the tile slicing procedure has been described in terms of a process that utilizes discrete wavelet transformation, quantization, and entropy encoding, the concept can be readily applied to various compression/encoding processes that may involve one or more types of data transformation, quantization and encoding processes.

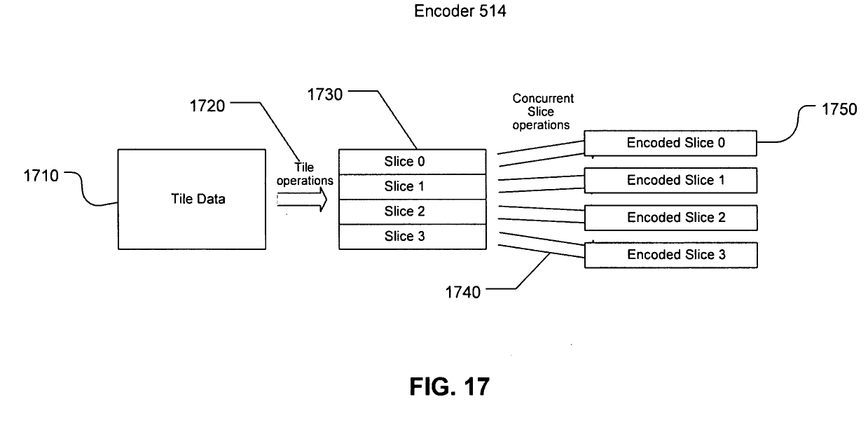

Referring to FIG. 17, illustrated is an example embodiment of a sliced tile encoding mechanism. Tile data 1710 may comprise a tile comprising bitmap data representing a portion of a virtual machine user display to be transmitted to a client device. Tile operations 1720 may represent various operations described above for processing the received data tiles. The operations may further include processes for dividing the tile into two or more slices. In the example shown, the tile data 1710 is divided into four slices 1730 for concurrent processing 1740. In an embodiment the four slices may be logical slices that divide the tile data 1710 into four equally sized slices. For example, a 16×16 tile may be divided into four 4×16 slices.

The slices 1730 may be further processed to generate processed slices 1750. As discussed above, the process may include encoding techniques such as entropy encoding. The processed slices 1750 may then be transmitted to a client computer for decoding. The slices may be transmitted over any type of network protocol and over wired or wireless networks.

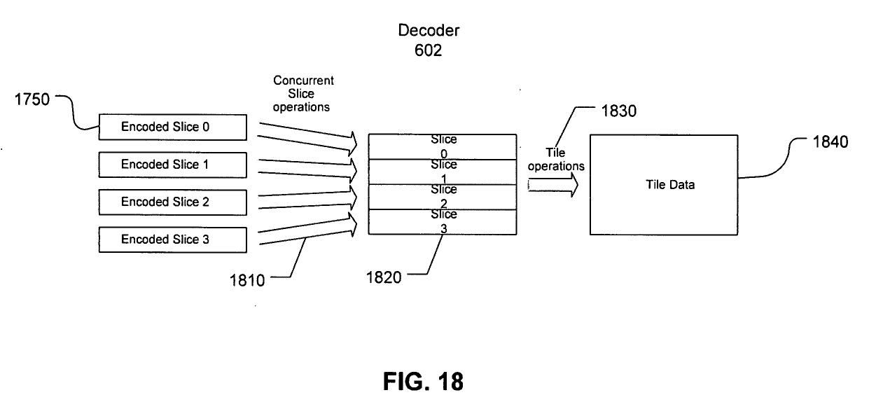

Referring to FIG. 18, the processed slices 1750 may be received by a decoder 602 on the client computer. The slices 1750 may then be processed concurrently 1810. For example, the slices may be decoded using a reverse entropy decoding technique to recover the original data slices 1820. The decoded slices may further be concatenated and further processed 1830 using, for example, dequantization and inverse transform operations. The original data tile 1840 may thus be re-generated.

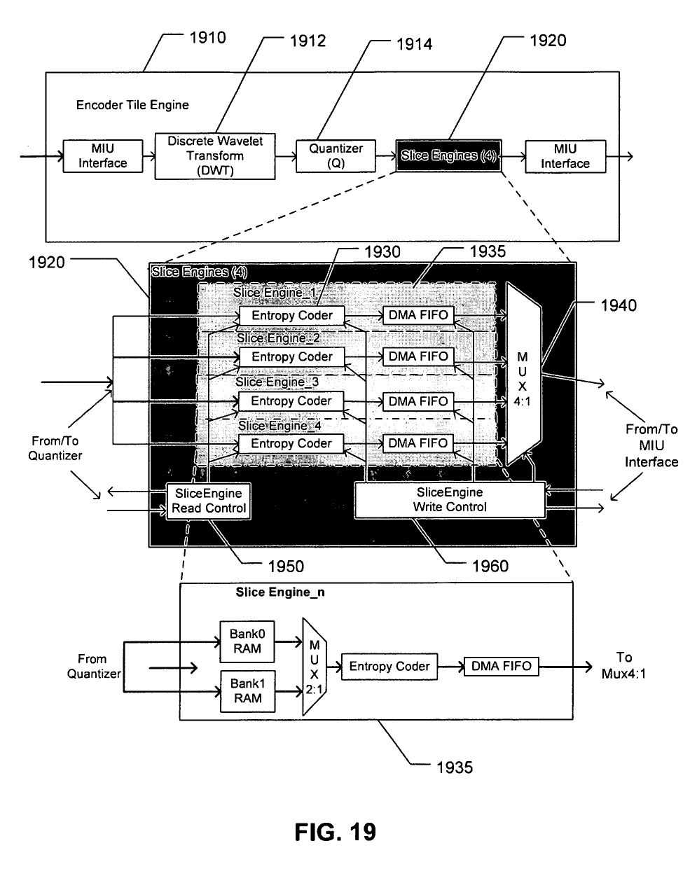

Referring to FIG. 19, illustrated is an example embodiment of a tile engine incorporating aspects of the disclosed subject matter. An encoder tile engine 1910 may be provided that performs an encoding process for received data tiles. For example, the encoder tile engine 1910 may include a discrete wavelet transform function 1912 and a quantization function 1914. The output of the quantization function 1914 may be input to the slice engines module 1920. The management and control of the tiles slices may be performed by a Slice Engine Read Controller 1950. Further detail of an exemplary embodiment of a slice engine module 1920 comprising four slice engines is depicted, including further detail of an exemplary slice engine 1935. Slice engine 1935 may further comprise an entropy encoder 1930 that performs an entropy encoding process on a tile slice. The tile slice may be an equal portion of a data tile output received from the quantization process 1914. While the current example illustrates a slice engine module 1920 that implements four slice engines, those skilled in the art will recognize that any number of slices may be implemented as desired per system performance objectives and other factors. The output of the entropy encoder 1930 may be queued and multiplexed by multiplexer 1940 to generate a multiplexed data stream comprising the encoded tile data. The encoding and multiplexing process may further be managed and controlled by a Slice Engine Write Controller 1960. The resulting encoded tile data and/or control data may then be transmitted to the client.

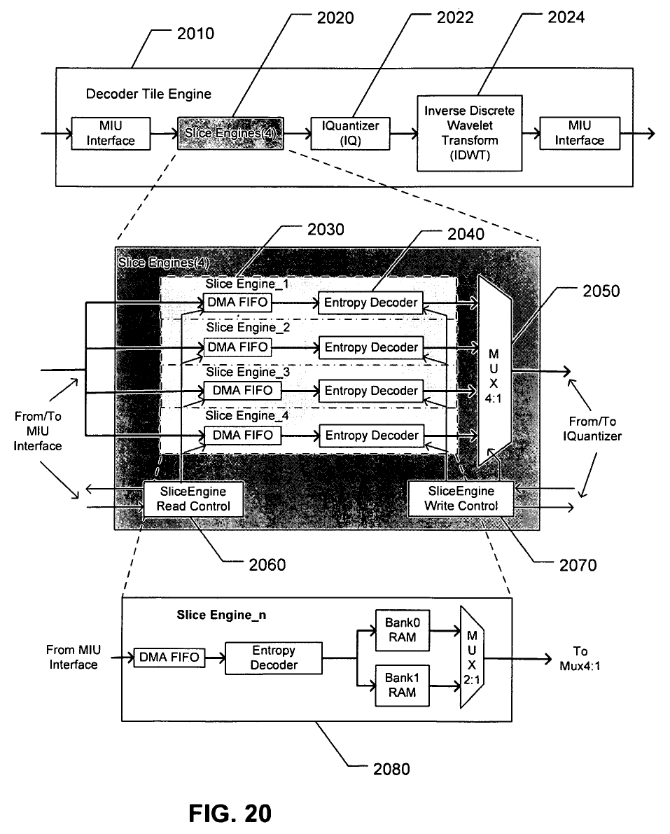

Referring to FIG. 20, illustrated is an example embodiment of a tile decoding engine incorporating aspects of the disclosed subject matter. A decoder tile engine 2010 may be provided that performs a decoding process for data tiles received from an encoding process similar to that illustrated in FIG. 19. For example, the received encoded tile data may be input to the slice engines module 2020. Further detail of an exemplary embodiment of a slice engine module 2020 comprising four slice engines is depicted, including further detail of an exemplary slice engine 2030. The management and control of the tiles slices may be performed by a Slice Engine Read Controller 2060. Slice engine 2030 may further comprise an entropy decoder 2040 that performs an entropy decoding process on an encoded tile slice. The encoded tile slice may be an encoded slice output from the entropy encoding process 1920 of FIG. 19. While the current example illustrates a slice engine module 2020 that implements four slice engines, those skilled in the art will recognize that any number of slices may be implemented as desired per system performance objectives and other factors. The output of the entropy decoder 2040 may be queued and multiplexed by multiplexer 2050 to generate a multiplexed data stream comprising the decoded tile data. The decoding and multiplexing process may further be managed and controlled by a Slice Engine Write Controller 2070. The resulting decoded tile data and/or control data may then be transmitted to an inverse quantization function 2022 and an inverse discrete wavelet transform function 2024 to complete the decoding process.

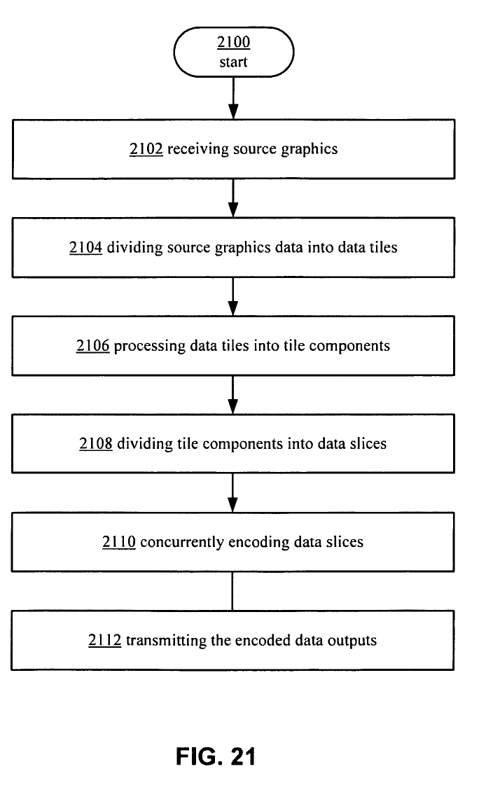

FIG. 21 depicts an exemplary operational procedure for compressing graphics data for transmission to a client computer including operations 2100, 2102, 2104, 2106, 2108, 2110, and 2112. Referring to FIG. 21, operation 2100 begins the operational procedure and operation 2102 illustrates receiving source graphics data from a data source. Operation 2104 illustrates dividing the source graphics data into data tiles. Operation 2106 illustrates processing the data tiles into tile components. Operation 2108 illustrates dividing each of the tile components into a quantity of data slices corresponding to a number of concurrent processes for encoding the data slices. Operation 2110 illustrates concurrently encoding the data slices to produce encoded data outputs corresponding to the data slices. Operation 2112 illustrates transmitting the encoded data outputs to the client computer.

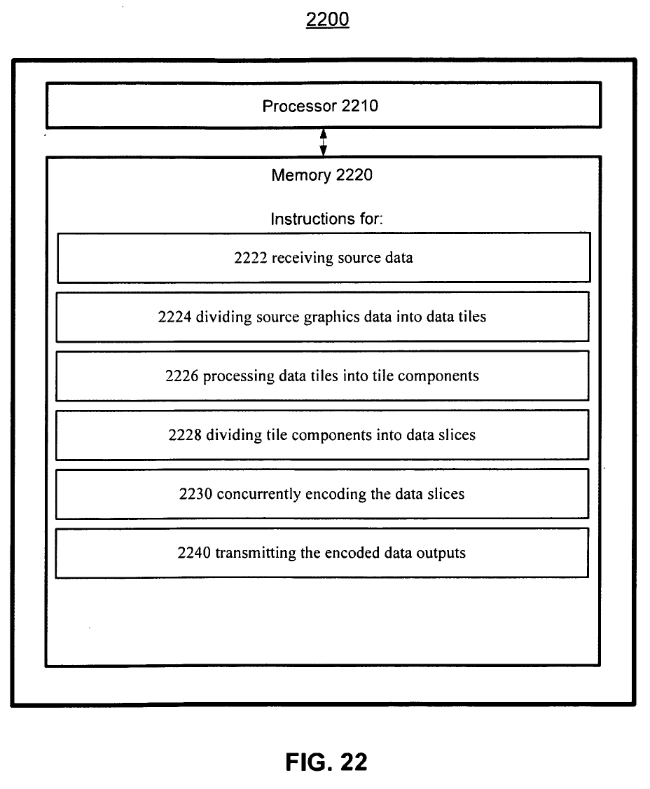

FIG. 22 depicts an exemplary system for compressing data for transmission to a client computer as described above. Referring to FIG. 22, system 2200 comprises a process 2210 and memory 2220. Memory 2220 further comprises computer instructions configured to compress data for transmission to a client computer. Block 2222 illustrates receiving source data from a data source. Block 2224 illustrates dividing the source graphics data into data tiles. Block 2226 illustrates processing the data tiles into tile components. Block 2228 illustrates dividing each of the tile components into a quantity of data slices corresponding to a number of concurrent processes for encoding the data slices. Block 2230 illustrates for each of said tile components, concurrently encoding the data slices to produce encoded data outputs corresponding to the data slices, the encoding using an encoding mode based upon pre-determined mode selection criteria. Block 2240 illustrates transmitting the plurality of encoded data outputs to the client computer.

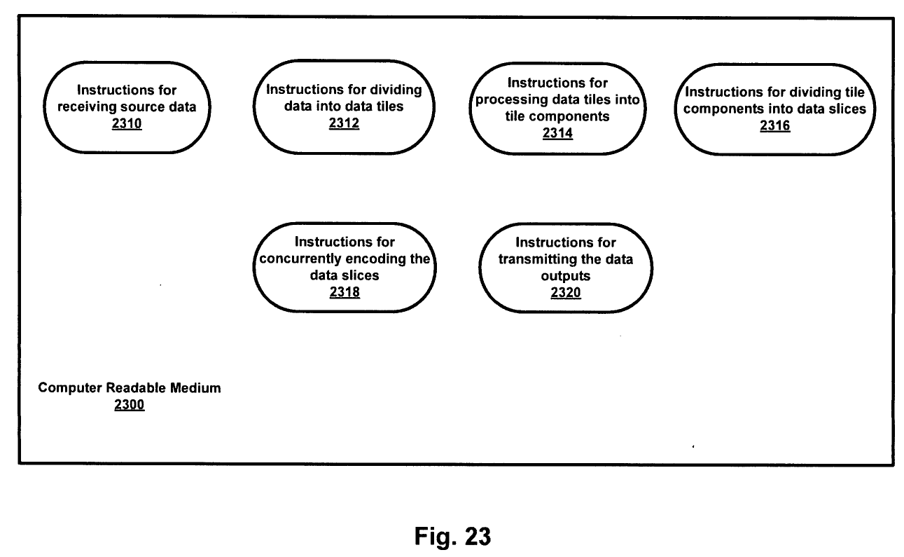

Any of the above mentioned aspects can be implemented in methods, systems, computer readable media, or any type of manufacture. For example, per FIG. 23, a computer readable medium can store thereon computer executable instructions for compressing data for transmission to a client computer. Such media can comprise a first subset of instructions for receiving source data from a data source 2310; a second subset of instructions for dividing the source graphics data into data tiles 2312; a third subset of instructions for processing the data tiles into tile components 2314; a fourth set of instructions for dividing each of the tile components into a quantity of data slices corresponding to a number of concurrent processes for encoding the data slices 2316; a fifth set of instructions for concurrently encoding the data slices to produce encoded data outputs corresponding to the data slices 2318; and a sixth set of instructions for transmitting the plurality of encoded data outputs to the client computer 2320. It will be appreciated by those skilled in the art that additional sets of instructions can be used to capture the various other aspects disclosed herein, and that the six presently disclosed subsets of instructions can vary in detail per the present disclosure.

As described above, aspects of the disclosure may execute on a programmed computer. FIG. 1 and the following discussion is intended to provide a brief description of a suitable computing environment in which the those aspects may be implemented. One skilled in the art can appreciate that the computer system of FIG. 1 can in some embodiments effectuate the server and the client of FIGS. 2-4. In these example embodiments, the server and client can include some or all of the components described in FIG. 1 and in some embodiments the server and client can each include circuitry configured to instantiate specific aspects of the present disclosure.

The term circuitry used through the disclosure can include specialized hardware components. In the same or other embodiments circuitry can include microprocessors configured to perform function(s) by firmware or switches. In the same or other example embodiments circuitry can include one or more general purpose processing units and/or multi-core processing units, etc., that can be configured when software instructions that embody logic operable to perform function(s) are loaded into memory, e.g., RAM and/or virtual memory. In example embodiments where circuitry includes a combination of hardware and software, an implementer may write source code embodying logic and the source code can be compiled into machine readable code that can be processed by the general purpose processing unit(s).

FIG. 1 depicts an example of a computing system which is configured to with aspects of the disclosure. The computing system can include a computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the computer 20, such as during start up, is stored in ROM 24. The computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. In some example embodiments, computer executable instructions embodying aspects of the disclosure may be stored in ROM 24, hard disk (not shown), RAM 25, removable magnetic disk 29, optical disk 31, and/or a cache of processing unit 21. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer readable media provide non volatile storage of computer readable instructions, data structures, program modules and other data for the computer 20. Although the environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the operating environment.

A number of program modules may be stored on the hard disk, magnetic disk 29, optical disk 31, ROM 24 or RAM 25, including an operating system 35, one or more application programs 36, other program modules 37 and program data 38. A user may enter commands and information into the computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A display 47 or other type of display device can also be connected to the system bus 23 via an interface, such as a video adapter 48. In addition to the display 47, computers typically include other peripheral output devices (not shown), such as speakers and printers. The system of FIG. 1 also includes a host adapter 55, Small Computer System Interface (SCSI) bus 56, and an external storage device 62 connected to the SCSI bus 56.

The computer 20 may operate in a networked environment using logical connections to one or more remote computers, such as a remote computer 49. The remote computer 49 may be another computer, a server, a router, a network PC, a peer device or other common network node, a virtual machine, and typically can include many or all of the elements described above relative to the computer 20, although only a memory storage device 50 has been illustrated in FIG. 1. The logical connections depicted in FIG. 1 can include a local area network (LAN) 51 and a wide area network (WAN) 52. Such networking environments are commonplace in offices, enterprise wide computer networks, intranets and the Internet.

When used in a LAN networking environment, the computer 20 can be connected to the LAN 51 through a network interface or adapter 53. When used in a WAN networking environment, the computer 20 can typically include a modem 54 or other means for establishing communications over the wide area network 52, such as the Internet. The modem 54, which may be internal or external, can be connected to the system bus 23 via the serial port interface 46. In a networked environment, program modules depicted relative to the computer 20, or portions thereof, may be stored in the remote memory storage device. It will be appreciated that the network connections shown are examples and other means of establishing a communications link between the computers may be used. Moreover, while it is envisioned that numerous embodiments of the disclosure are particularly well-suited for computer systems, nothing in this document is intended to limit the disclosure to such embodiments.

The foregoing detailed description has set forth various embodiments of the systems and/or processes via examples and/or operational diagrams. Insofar as such block diagrams, and/or examples contain one or more functions and/or operations, it will be understood by those within the art that each function and/or operation within such block diagrams, or examples can be implemented, individually and/or collectively, by a wide range of hardware, software, firmware, or virtually any combination thereof.

While particular aspects and embodiments of the disclosure described herein have been shown and described, it will be apparent to those skilled in the art that, based upon the teachings herein, changes and modifications may be made and, therefore, the appended claims are to encompass within their scope all such changes and modifications as are within the true spirit and scope of the disclosures described herein.

What is claimed:

1. In a system comprising a processor and memory, a method for compressing graphics data for transmission to a client computer, the method comprising:
receiving source graphics data from a data source and dividing said source graphics data into data tiles;
processing said data tiles into tile components;
dividing each of said tile components into a quantity of data slices corresponding to a number of concurrent processes for encoding the data slices;
for each of said tile components, concurrently encoding the data slices to produce encoded data outputs corresponding to the data slices; and
transmitting the encoded data outputs to said client computer.

2. The method of claim 1, wherein the graphics data is bitmap data representing display graphics of a virtual machine session.

3. The method of claim 1, wherein the tile components are YUV components.

4. The method of claim 3, further comprising performing a discrete wavelet transformation on said data tiles.

5. The method of claim 4, further comprising performing a quantization process on the output of said discrete wavelet transformation.

6. The method of claim 5, wherein the number of concurrent processes is four.

7. The method of claim 1, wherein said encoding is entropy encoding.

8. The method of claim 1, wherein the concurrent processes are executed in software on a multi-core CPU.

9. The method of claim 1, wherein the concurrent processes are executed in custom hardware.

10. The method of claim 5, further comprising providing an arbiter for collecting data from the quantization process and distributing the data slices to the concurrent processes.

11. A system configured to compress data for transmission to a client computer, comprising:
at least one processor; and
at least one memory communicatively coupled to said at least one processor, the memory having stored therein computer-executable instructions for:
receiving source data from a data source and dividing said source graphics data into data tiles;
processing said data tiles into tile components;
dividing each of said tile components into a quantity of data slices corresponding to a number of concurrent processes for encoding the data slices;
for each of said tile components, concurrently encoding the data slices to produce encoded data outputs corresponding to the data slices, said encoding using an encoding mode based upon pre-determined mode selection criteria; and
transmitting the plurality of encoded data outputs to said client computer.

12. The system of claim 11, wherein the concurrent processes are executed in software on a multi-core CPU.

13. The system of claim 11, wherein the concurrent processes are executed in custom hardware.

14. The system of claim 11, further comprising further comprising performing a transformation on said data tiles.

15. The system of claim 14, further comprising performing a quantization process on the output of said transformation.

16. The system of claim 15, wherein said encoding is entropy encoding.

17. A computer readable storage medium storing thereon computer executable instructions for compressing data for transmission to a client computer, said instructions for:
receiving source data from a data source and dividing said source graphics data into data tiles;
processing said data tiles into tile components;
dividing each of said tile components into a quantity of data slices corresponding to a number of concurrent processes for encoding the data slices;
for each of said tile components, concurrently encoding the data slices to produce encoded data outputs corresponding to the data slices; and
transmitting the plurality of encoded data outputs to said client computer.

18. The computer readable storage medium of claim 17, wherein the source data is bitmap data representing display graphics of a virtual machine session.

19. The computer readable storage medium of claim 17, wherein said encoding is entropy encoding, further comprising instructions for:
performing a discrete wavelet transformation on said data tiles; and
performing a quantization process on the output of said discrete wavelet transformation.

20. The computer readable storage medium of claim 19, further comprising instructions for arbitrating the collection of data from the quantization process and distributing the data slices to the concurrent processes.
